(19) United States
(12) Patent Application Publication
(10) Pub. No.: US 2014/0066340 A1
(43) Pub. Date: Mar. 6, 2014

(54) Low Toxicity Viscosifier and Methods of Using the Same

(71) Applicant: Michael Herman Hoff, Magnolia, TX (US)

(72) Inventor: Michael Herman Hoff, Magnolia, TX (US)

(73) Assignee: Halliburton Energy Services, Inc., Houston, TX (US)

(21) Appl. No.: 13/598,967

(22) Filed: Aug. 30, 2012

(51) Int. Cl. C09K 8/34; C09K 8/00

(52) U.S. Cl. 507/114; 507/216

(57) ABSTRACT

Viscosifying compositions having reduced toxicity are used in treatment fluids in subterranean operations; methods include providing such treatment fluids including a viscosifying composition and an aqueous base fluid, the viscosifying composition including hydroxyethyl cellulose, about 10% to about 60% by weight of 2-pyrrolidone, and about 10% to about 60% by weight of a water soluble monoalkyl ether of propylene glycol having substantially no swelling effect on the hydroxyethyl cellulose, wherein a weight ratio of hydroxyethyl cellulose to 2-pyrrolidone is in a range from about 1:2 to about 2.6:1 and the method including placing the treatment fluid in a subterranean formation.

### BACKGROUND

The present invention relates to viscosifying compositions employed in treatment fluids and the use of such treatment fluids in subterranean operations, and more particularly, to viscosified treatment fluids having reduced toxicity.

Compositions containing modified celluloses, such as hydroxyethyl cellulose (HEC), carboxymethylcellulose, methylcellulose, and ethylcellulose may be used to viscosify aqueous fluids such as heavy brines commonly employed as well bore servicing fluids, if the modified cellulose is properly formulated. For example, a mixture of HEC, a solvating agent, which is an agent that pre-hydrates HEC, and a diluent which is a non-solvating agent for HEC may be used to viscosify heavy brines, i.e., brines having a density greater than about 11.7 pounds per gallon (ppg), and more generally from about 12.0 ppg to about 19.2 ppg. It has also been indicated that in a viscosifying composition containing HEC, certain amino compounds and an organic liquid, which does not pre-hydrate the HEC, may be useful in viscosifying heavy brines at ambient temperatures.

An issue that arises with conventional viscosifying compositions, especially in the context of brine treatment fluids, is the attendant toxicity associated with various additives employed in the viscosifying compositions. For example, HEC has been formulated in a viscosifying composition comprising monoalkyl ethers of ethylene glycol. Monoalkyl ethers of ethylene glycol are known to be toxic and in numerous jurisdictions have been banned from use or are in the process of being banned.

In addition to issues of toxicity, other viscosifying compositions, such as those based on xanthan gum, lack robust fluid loss control characteristics required of a non-damaging fluid. Moreover, typical fluid loss or seepage control agents that might be used to ameliorate fluid loss in xanthan gum-based treatment fluids, such as starch, mica, hard nut shells, and the like are too permanent, and may interfere with production of the well after completion. Guar gum, another viscosifying biopolymer, has been indicated to damage formations and has fallen out of favor as a viable viscosifying additive in wellbore treatment fluids.

Finely divided calcium carbonate (limestone) combined with fluids based on HEC or polyoxyethylene have been used as viscosifying compositions with favorable fluid loss properties. The disadvantage of calcium carbonate as a fluid loss sealing agent, however, is that it must be dissolved with acid before the well can be brought into production.

### SUMMARY OF THE INVENTION

The present invention relates to viscosifying compositions employed in treatment fluids and the use of such treatment fluids in subterranean operations, and more particularly, to viscosified treatment fluids having reduced toxicity.

In some embodiments, the present invention provides methods comprising providing treatment fluids comprising viscosifying compositions and aqueous base fluids, the viscosifying compositions comprising hydroxyethyl cellulose, about 10% to about 60% by weight of 2-pyrrolidone, and about 10% to about 60% by weight of a water soluble monoalkyl ether of a propylene glycol having substantially no observable swelling effect on the hydroxyethyl cellulose, wherein a weight ratio of hydroxyethyl cellulose to 2-pyrrolidone comprises a range from about 1:2 to about 2.6:1 and the method comprising placing the treatment fluid in a subterranean formation.

In other embodiments, the present invention provides treatment fluids comprising a viscosifying composition and an aqueous base fluid, the viscosifying composition comprising hydroxyethyl cellulose, about 10% to about 60% by weight of 2-pyrrolidone, and about 10% to about 60% by weight of a water soluble monoalkyl ether of propylene glycol having substantially no observable swelling effect on the hydroxyethyl cellulose, wherein a weight ratio of hydroxyethyl cellulose to 2-pyrrolidone comprises a range from about 1:2 to about 2.6:1.

In still other embodiments, the present invention provides treatment fluids comprising a viscosifying composition and a brine base fluid, the viscosifying composition comprising hydroxyethyl cellulose, about 10% to about 60% by weight of 2-pyrrolidone, and about 10% to about 60% by weight of a water soluble monoalkyl ether of propylene glycol having substantially no observable swelling effect on the hydroxyethyl cellulose, wherein a weight ratio of hydroxyethyl cellulose to 2-pyrrolidone comprises a range from about 1:2 to about 2.6:1.

In still other embodiments, the present invention provides methods comprising providing a treatment fluid comprising a viscosifying composition and an aqueous base fluid, the viscosifying composition comprising hydroxyethyl cellulose, about 10% to about 60% by weight of 2-pyrrolidone, and about 10% to about 60% by weight of a water soluble monoalkyl ether of propylene glycol having substantially no observable swelling effect on the hydroxyethyl cellulose, wherein a weight ratio of hydroxyethyl cellulose to 2-pyrrolidone comprises a range from about 1:2 to about 2.6:1, and the method comprising placing the treatment fluid in a subterranean formation as part of a workover or completion operation.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a plot showing the standard reference toxicant (SDS) test with A. Bahia as a baseline measure of the health of the A. Bahia population.

### DETAILED DESCRIPTION

The present invention relates to viscosifying compositions employed in treatment fluids and the use of such treatment fluids in subterranean operations, and more particularly, to viscosified treatment fluids having reduced toxicity.

Among the numerous advantages, the present invention provides viscosifying compositions that may be suitable for use with a large array of treatment fluids, including heavy brines (even bromide-containing brines) that may be employed in well workover and completion operations, while reducing the associated toxicity with conventional viscosifying compositions.

Furthermore, the viscosifying compositions of the invention may exhibit beneficial fluid loss characteristics and reduced tendency to cause formation damage. The viscosifying compositions of the invention may be readily solubilized in acid and may contain little or no petroleum hydrocarbon to avoid sheening. When employed in treatment fluids, the viscosifying compositions of the invention may be useful in (1) cleaning operations while milling or underreaming, (2) as part of a brine used in gravel packing operations, or (3) formulated as part of a spacer fluid.

Another valuable feature of the viscosifying compositions of the present invention is that organophilic clay-like materials are not necessary to formulate certain well servicing fluids. Such clay containing materials are undesirable in clear well servicing fluids used for workover and completion operations. Also, since the viscosifying compositions of the present invention are essentially non-aqueous, problems associated with rusting of containers used to transport and store the thickening agents are eliminated.

In some embodiments, the present invention provides methods comprising providing treatment fluids comprising viscosifying compositions and aqueous base fluids, the viscosifying compositions comprising hydroxyethyl cellulose, about 10% to about 60% by weight of 2-pyrrolidone, and about 10% to about 60% by weight of a water soluble monoalkyl ether of propylene glycol having substantially no observable swelling effect on the hydroxyethyl cellulose. In some such embodiments, the weight ratio of hydroxyethyl cellulose to 2-pyrrolidone may be in a range from about 1:2 to about 2.6:1. The methods further comprise placing the treatment fluid in a subterranean formation.

The viscosifying compositions of the present invention may use a hydrophilic polymer such as hydroxyethyl cellulose (HEC) to provide the viscosifying effect. HEC polymers, in particular, are valued as non-damaging viscosifying agents and may be used unmodified off the shelf. Other hydrophilic polymers may be employed in lieu of HEC including, without limitation, methylcellulose, ethylcellulose, and the like. The exact choice of alternative hydrophilic polymer may be governed by properties such as good acid solubility and compatibility with brines, along with the requisite non-damaging impact on the formation. HEC polymers are solid, particulate materials that are water-soluble or water-dispersible and that upon solution or dispersion in an aqueous medium increase the viscosity of the medium. HEC polymers are generally high-yield, water soluble, non-ionic materials produced by treating cellulose with sodium hydroxide followed by reaction with ethylene oxide. Each anhydroglucose unit in the cellulose molecule has three reactive hydroxy groups. The average number of moles of the ethylene oxide that covalently attach to each anhydroglucose unit in cellulose is called moles of substituent combined. In general, the greater the degree of substitution (DS), the greater the water solubility, as well as the greater the viscosity when added to an aqueous fluid. In some embodiments, it is preferable to use HEC polymers having as high a degree of substitution as possible, for example, a DS of at least 1.0, or a DS of at least 2.0, or a DS of at least 2.5.

In addition to HEC, the viscosifying compositions of the present invention also contain 2-pyrrolidone and a monoalkyl ether of propylene glycol. Without being bound by theory, the 2-pyrrolidone may serve at least two functions. The primary function may be to “activate” the HEC by making it more accessible to water. The secondary function may be to swell the HEC providing swelled volume to the polymer, helping to prevent packing of the HEC in containers. Similarly, the monoalkyl ether may also serve at least two functions. First it may serve as a diluent/carrier fluid. Second, it may function as a dispersant, rapidly dispersing the HEC in brines to prevent the formation of partially wetted polymer globules called “fisheyes.” The mono alkyl ethers of propylene glycol useful in the compositions of the present invention are those ethers that are water-soluble or water-miscible and exert substantially no swelling effect on the HEC.

For purposes of determining if a given ether is suitable for use in the compositions of the present invention, based on the degree of swelling, the following test may be used: two parts by weight of the liquid ether is mixed with one part by weight of the HEC in a sealable container, and the mixture allowed to remain in a quiescent state in the sealed container for a period of about one week. If the ether being tested has substantially no observable swelling effect on the HEC, there will be free, liquid ether in the container after the one week period. The amount of liquid may be substantially all of the liquid except that amount engaged in wetting the HEC polymer. As used herein, “substantially no observable swelling effect” means that the degree of swelling is less than about 1%. This amount of swelling can be seen visually, without the aid of instrumentation. Non-limiting examples of suitable ethers within the scope of the present invention include propylene glycol monobutyl ether (2-butoxypropanol), propylene glycol isobutyl ether (2-(2-butoxyethoxy)-propanol), and the like. Any water miscible propylene glycol is useful. A variety of monoalkyl ethers may be useful in the practice of the present invention and may be limited only by the lack of sufficient solubility or miscibility in water. In some embodiments, the monoalkyl ether of propylene glycol comprises one selected from the group consisting of propylene glycol n-propyl ether, dipropylene glycol methyl ether, and tripropylene glycol methyl ether.

Despite similarities in chemical structure, propylene glycol ethers are generally far less toxic than ethylene glycol ethers. Ethylene glycol ethers have been shown to be toxic to rapidly dividing cells such as testis and bone marrow and are reproductive toxins. They are known animal tetratogens and are known to cause hematological, embryo, fetal and maternal toxicity.

Although quite similar in chemical structure, propylene glycol ethers do not exhibit the toxicity of ethylene glycol ethers. Without being bound by theory, it has been indicated that the difference in toxicity between propylene glycol ethers and ethylene glycol ethers may be most likely due to different metabolic pathways. Ethylene glycol ethers may be metabolized through alcohol dehydrogenase to form alkoxy acetic acid, a toxic metabolite. By contrast, propylene glycol ether may be degraded through the microsomal enzymes system in a body to form relatively innocuous metabolites such as propylene glycol.

In some embodiments, methods of the invention may employ viscosifying compositions in which the weight ratio of hydroxyethyl cellulose to 2-pyrrolidone comprises a range from about 1:2 to about 2.6:1. In particular embodiments, the viscosifying compositions of the present invention use HEC in a weight ratio of HEC polymer to 2-pyrrolidone of less than about 2.6:1 and in the range from about 1:2 to about 2.6:1, including any ratio there between. Desirable compositions, which are pourable liquids, and which will effectively viscosify aqueous mediums can be produced from compositions containing from about 10% to about 25% by weight HEC polymer, from about 10% to about 60% by weight 2-pyrrolidone and from about 10% to about 60% by weight of the mono alkyl ether of ethylene glycol.

In some embodiments, methods of the invention employ treatment fluids further comprising at least one water-soluble salt of a multivalent metal ion. In some such embodiments, the at least one water soluble salt of a multivalent metal ion comprises one selected from the group consisting of calcium chloride, calcium bromide, zinc chloride, zinc bromide, and combinations thereof. Thus, such treatment fluids comprise heavy brines with a density greater than about 11.7 ppg, in particular densities in a range from about 12.0 ppg to about 19.2 ppg.

In some embodiments, methods of the invention employ treatment fluids that further comprise glycerine. In some embodiments, methods of the invention employ treatment fluids that further comprise an additive selected from the group consisting of inert solids, fluid loss control agents, dispersion aids, corrosion inhibitors, gelling agents, surfactants, particulates, proppants, gravel particulates, lost circulation materials, defoamers, filtrate reducers, pH control additives, breakers, biocides, crosslinkers, stabilizers, chelating agents, scale inhibitors, gas hydrate inhibitors, mutual solvents, oxidizers, reducers, flocculants, friction reducers, clay stabilizing agents, shale control inhibitors, and any combination thereof.

While a number of embodiments described herein relate to viscosified heavy brines that may be typically used in completion and workover operations, it is understood that any well treatment fluid such as drilling, completion and stimulation fluids including, but not limited to, pills, drilling muds, well cleanup fluids, workover fluids, spacer fluids, gravel pack fluids, acidizing fluids, fracturing fluids, and the like, may be prepared using treatment fluid of the present invention comprising viscosifying compositions disclosed herein. Accordingly, an example of a method of the present invention is a method of using a treatment fluid in a subterranean formation comprising introducing a treatment fluid comprising a viscosifying composition, in accordance with embodiments disclosed herein, into the subterranean formation, wherein the fluid comprises a base fluid and the viscosifying composition. Additional steps include drilling, completing and/or stimulating a subterranean formation using the treatment fluid; and/or producing a fluid, e.g., a hydrocarbon fluid such as oil or gas, from the subterranean formation. In some embodiments, methods of the invention employ treatment fluids disclosed herein as workover fluids. In some embodiments, methods of the invention employ treatment fluids that are formulated as completion fluids. In some embodiments, methods of the invention employ treatment fluids that are formulated as drilling fluids. In some embodiments, the methods disclosed herein may be based on land, while in other embodiments, methods disclosed herein may be based off-shore.

In some embodiments, the present invention provides treatment fluids comprising viscosifying compositions and aqueous base fluids, the viscosifying composition comprising hydroxyethyl cellulose, about 10% to about 60% by weight of 2-pyrrolidone; and about 10% to about 60% by weight of a water soluble monoalkyl ether of propylene glycol having substantially no observable swelling effect on the hydroxyethyl cellulose, wherein a weight ratio of hydroxyethyl cellulose to 2-pyrrolidone may be in a range from about 1:2 to about 2.6:1. In some such embodiments, the monoalkyl ether of propylene glycol comprises one selected from the group consisting of propylene glycol n-propyl ether, dipropylene glycol methyl ether, and tripropylene glycol methyl ether.

In some embodiments, the treatment fluids of the invention may be formulated with a weight ratio of hydroxyethyl cellulose to 2-pyrrolidone comprising a range from about 2.6:1 to about 1:2 or wherein the hydroxyethyl cellulose is present in a range from about 10% to about 25% by weight.

In some embodiments, treatment fluids of the invention, further comprise at least one water soluble salt of a multivalent metal ion. For example, in some embodiments, the at least one water soluble salt of a multivalent metal ion comprises one selected from the group consisting of calcium chloride, calcium bromide, zinc chloride, zinc bromide, and combinations thereof. In some such embodiments, the treatment fluids of the invention may have densities in a range from about 12.0 ppg to about 19.2 ppg.

In some embodiments, the present invention provides treatment fluids comprising viscosifying compositions and brine base fluids, the viscosifying composition comprising hydroxyethyl cellulose, about 10% to about 60% by weight of 2-pyrrolidone, and about 10% to about 60% by weight of a water soluble monoalkyl ether of propylene glycol having substantially no observable swelling effect on the hydroxyethyl cellulose, wherein a weight ratio of hydroxyethyl cellulose to 2-pyrrolidone may be in a range from about 1:2 to about 2.6:1. In some embodiments, the treatment fluids comprise viscosified heavy brines, particularly those used for well servicing fluids, i.e. completion and workover fluids, and are made from brines having a density greater than about 11.7 ppg, and in some embodiments, from about 12 ppg to about 19.2 ppg. In some embodiments, heavy brines comprise water solutions of salts selected from the group consisting of calcium chloride, calcium bromide, zinc chloride, zinc bromide, and mixtures thereof. Generally, in formulating well servicing fluids using heavy brines, the viscosifying composition may be present in an amount of from about 0.5 to about 3 ppb, calculated as active HEC.

In some embodiments, methods of the invention comprise providing treatment fluids comprising a viscosifying composition and an aqueous base fluid, the viscosifying composition comprising hydroxyethyl cellulose, about 10% to about 60% by weight of 2-pyrrolidone, and about 10% to about 60% by weight of a water soluble monoalkyl ether of propylene glycol having substantially no observable swelling effect on the hydroxyethyl cellulose, wherein a weight ratio of hydroxyethyl cellulose to 2-pyrrolidone may be in a range from about 1:2 to about 2.6:1, and the method comprising placing the treatment fluid in a subterranean formation as part of a workover or completion operation. In some such embodiments, the aqueous base fluid is a brine.

While the viscosifying compositions of the present invention are useful as viscosifiers or suspending agents in numerous systems which require viscosity enhancement, they may find particular utility in the preparation of well servicing fluids and, more particularly, well servicing fluids made from aqueous mediums containing soluble salts such as, for example, a soluble salt of an alkali metal, an alkaline earth metal, a Group IB metal, a Group IIB metal, as well as water soluble salts of ammonia and other cations. The viscosifying compositions may be particularly useful in the preparation of viscosified heavy brines, i.e. aqueous solutions of soluble salts of multivalent cations, e.g., Zn and Ca.

To facilitate a better understanding of the present invention, the following examples of preferred or representative embodiments are given. In no way should the following examples be read to limit, or to define, the scope of the invention.

### EXAMPLES

Example I provides the general procedure for preparing viscosifying compositions. Example II shows an exemplary composition using the more toxic ethylene glycol ether for comparison purposes. In Examples III-VII below, various viscosifying compositions employing propylene glycol ethers were screened to characterize their rheology. In Examples II-VII, the compositions were tested by measuring time to viscosify a 16 lb/gal (1.917 g/cm³) winter blend of CaBr₂/ZnBr₂. Test concentration of HEC polymer was 1.5 lb/bbl (4.28 kg/m³) active that was 7.5 (21.38 kg/m³) lb/bbl as received (1.5/0.2). Test brine formulation was 0.6400 bbl 14.2 lb/gal CaBr₂+0.3600 bbl 19.2 lb/gal CaBr₂/ZnBr₂ (0.10175 m³ 1.70 g/cm³ CaBr₂+0.05724 m³ 2.3 g/cm³ CaBr₂/ZnBr₂).

The viscosity profile was measured over a 1 hour period using a Fann 35A rheometer. The rheometer was fitted with an R1-B1-F1 rotor-bob-torsion spring combination. Test brine was placed on the rheometer and stirred at the 600 rpm setting and 1.5 grams (0.053 oz.) of active ingredient, HEC (7.5 grams (0.265 oz.) of the actual product), was added to the brine while stirring on the rheometer. As the product dispersed, viscosity increased. The viscosity at 600 and 300 rpm was measured every 15 minutes for an hour. After one hour the viscosified brine was rolled in a roller oven at 150° F./65° C. to achieve full viscosity. After overnight rolling (aprox 16 hours) and after cooling the sample to room temperature, the viscosity was again measured. The 600 rpm viscosity after the initial hour of mixing was divided by the 600 rpm viscosity after overnight rolling. This value is used as a measure of the viscosification efficiency of the product.

### Example I

General Procedure: This Example uses the mixture of compounds shown below in Formulation I and is provided as an exemplary procedure for preparing viscosifying compositions in accordance with embodiments disclosed herein. Arcosolv TPM (tripropylene glycol methyl ether, Lyondell Basell) and Pyrol (2-pyrrolidone) were combined and mixed for approximately 30 seconds. Mixing was performed on a Caframo mixer at approximately 700 rpm. BARAVIS® (HEC-based polymer, Halliburton, Duncan Okla.) was then added and the mixture dispersed quickly without lumps. Mixing was continued until sufficient thickening had occurred. After 2 hours the HEC polymer had swollen and after 3 hours the relatively thin product was poured into a jar. After setting overnight there was no packing and a slight top oil was present. After setting 3 days there was a ½ inch (1.27 cm) top oil that had separated.

Formulation I

| Components | Wt % | gm (oz) |
|---|---|---|
| TPM | 50 | 100 (3.53) |
| Pyrol | 30 | 60 (2.12) |
| BARAVIS | 20 | 40 (1.41) |

### Example II

Formulation II was prepared as in Example I using Butyl Blend (ethylene glycol butyl ether) in place of TPM.

Formulation II

| Components | Wt % | gm (oz) |
|---|---|---|
| Butyl Blend | 50 | 100 (3.53) |
| Pyrol | 30 | 60 (2.12) |
| BARAVIS | 20 | 40 (1.41) |

Viscosifying composition of Formulation II was added to a 16.0 lb/gal (1.917 g/cm³) winter blend formulation shown in Table I below and viscosity measurements were taken. The results of the viscosity measurements are summarized in Table II.

TABLE I
16.0 lb/gal (1.917 g/cm³) Winter Blend
Formulation

| | | |
|---|---|---|
| 14.2 lb/gal (1.7 g/cm³) | 0.3600 | bbl |
| CaBr₂ | (0.05724 | m³) |
| 19.2 lb/gal (2.3 g/cm³) | 0.6400 | bbl |
| CaBr₂/ZnBr₂ | (0.10175 | m³) |

TABLE II

| | 16.0 lb/gal (1.917 g/cm³) Winter Blend | | | | | |
|---|---|---|---|---|---|---|
| | 1.5 lb (0.68 kg) | | | | | |
| | active | | | | roll 150° F./ | |
| | 7.5 gm (0.26 oz) | | | | 65° C. | Dial |
| Formulation II | as recvd | | | | 16 hr | Reading |
| Time Min. | 600 | rpm | 300 | rpm | 600 rpm | 161 |
| 0 | 18 | | 9 | | 300 rpm | 114 |
| 10 | 38 | | 20 | | 200 rpm | 92 |
| 20 | 50 | | 29 | | 100 rpm | 66 |
| 30 | 60 | | 35 | | 6 rpm | 14 |
| 40 | 67 | | 40 | | 3 rpm | 9 |
| 50 | 70 | | 42 | | | |
| 60 | 75 | | 47 | | | |

| | |
|---|---|
| % viscosity potential achieved after 60 minutes | 46.6% |

These results indicate that 46.6% of the viscosity potential is achieved after 1 hour at 600 RPM (75/161).

### Example III

The viscosifying composition of Formulation III was mixed on a Caframo mixer for one hour. The TPM, glycerine, and Pyrol were combined and mix for 5 minutes. BARAVIS® was then added and the viscosifying composition was mixed for 1 hour. After setting overnight, there was no packing and only a slight top oil separation. The formulation had a moderate consistency and was very pourable. After setting for 3 days there was a ¼-inch top oil separation. Rheology results are shown in Table IIIa and Table IIIb.

Formulation III

| Components | Wt % | gm (oz) |
|---|---|---|
| TPM | 45 | 90 (3.17) |
| Glycerine | 5 | 10 (0.35) |
| Pyrol | 30 | 60 (2.12) |
| BARAVIS | 20 | 40 (1.41) |

TABLE IIIa

| | 11.6 lb/gal (1.39 g/cm³) | | | | | |
|---|---|---|---|---|---|---|
| | 1.5 lb (0.68 kg) | | | | | |
| | active | | | | | |
| | 7.5 gm (0.26 oz) | | | | roll 150° F./ | Dial |
| Formulation III | as recvd | | | | 65° C. 16 hr | Reading |
| Time Min. | 600 | rpm | 300 | rpm | 600 rpm | 169 |
| 0 | 18 | | 9 | | 300 rpm | 120 |
| 10 | 98 | | 62 | | 200 rpm | 99 |
| 20 | 144 | | 95 | | 100 rpm | 72 |
| 30 | 159 | | 109 | | 6 rpm | 19 |
| 40 | 162 | | 113 | | 3 rpm | 13 |
| 50 | 162 | | 114 | | | |
| 60 | 162 | | 114 | | | |

| | |
|---|---|
| % viscosity potential achieved after 60 minutes | 95.9% |

These results indicate that 95.9% of the viscosity potential is achieved after 1 hour at 600 RPM (162/169).

TABLE IIIb

| | 16 lb/gal (1.917 g/cm³) Winter Blend | | | | | |
|---|---|---|---|---|---|---|
| | 1.5 lb (0.68 kg) | | | | | |
| | active | | | | roll | |
| | 7.5 gm (0.26 oz) | | | | 150° F./65° C. | Dial |
| Formulation III | as recvd | | | | 16 hr | Reading |
| Time Min. | 600 | rpm | 300 | rpm | 600 rpm | 166 |
| 0 | 18 | | 9 | | 300 rpm | 119 |
| 10 | 37 | | 20 | | 200 rpm | 99 |
| 20 | 47 | | 26 | | 100 rpm | 73 |
| 30 | 55 | | 32 | | 6 rpm | 23 |
| 40 | 62 | | 38 | | 3 rpm | 16 |
| 50 | 68 | | 42 | | | |
| 60 | 72 | | 46 | | | |

| | |
|---|---|
| % viscosity potential achieved after 60 minutes | 43.4% |

### Example IV

Following the general procedure with viscosifying composition of Formulation IV below provided a mixture that gelled significantly. Mixing was stopped after 30 minutes and the mixture was allowed to set overnight. The sample was still stirrable, but slightly grainy and dry. After setting for 3 days, a ⅛ inch top oil had separated. Rheology results are shown in Table IV.

Formulation IV

| Components | Wt % | gm (oz) |
|---|---|---|
| TPM | 40 | 80 (2.82) |
| Pyrol | 40 | 80 (2.82) |
| BARAVIS | 20 | 40 (1.41) |

TABLE IV

| | 16 lb/gal (1.917 g/cm³) Winter Blend | | | | | |
|---|---|---|---|---|---|---|
| | 1.5 lb (0.68 kg) | | | | | |
| | active | | | | roll | |
| | 7.5 gm (0.26 oz) | | | | 150° F./65° C. | Dial |
| Formulation IV | as recvd | | | | 16 hr | Reading |
| Time Min. | 600 | rpm | 300 | rpm | 600 rpm | 160 |
| 0 | 18 | | 9 | | 300 rpm | 115 |
| 10 | 37 | | 19 | | 200 rpm | 96 |
| 20 | 56 | | 32 | | 100 rpm | 71 |
| 30 | 69 | | 42 | | 6 rpm | 22 |
| 40 | 82 | | 52 | | 3 rpm | 16 |
| 50 | 92 | | 59 | | | |
| 60 | 100 | | 65 | | | |

| | |
|---|---|
| % viscosity potential achieved after 60 minutes | 62.5% |

These results indicate that 62.5% of the viscosity potential is achieved after 1 hour at 600 RPM (100/160).

### Example V

Following the general procedure with viscosifying composition of Formulation V below, after 30 minutes the sample thickened. Speed was increased from 700 to 1050 rpm. After one hour of stirring the consistency was deemed excellent and the mixture was very pourable. After setting 3 days, there was a ⅛ inch top oil that had separated, but the mixture was still readily pourable. There was almost a ½ inch top oil that had separated after 5 days. Rheology results are shown in Table V.

Formulation V

| Components | Wt % | gm (oz) |
|---|---|---|
| TPM | 45 | 90 (3.17) |
| Pyrol | 35 | 70 (2.47) |
| BARAVIS | 20 | 40 (1.41) |

TABLE V

| | 16 lb/gal (1.917 g/cm³) Winter Blend | | | | | |
|---|---|---|---|---|---|---|
| | 1.5 lb (0.68 kg) | | | | | |
| | active | | | | roll | |
| | 7.5 gm (0.26 oz) | | | | 150° F./65° C. | Dial |
| Formulation V | as recvd | | | | 16 hr | Reading |
| Time Min. | 600 | rpm | 300 | rpm | 600 rpm | 167 |
| 0 | 18 | | 9 | | 300 rpm | 120 |
| 10 | 26 | | 13 | | 200 rpm | 100 |
| 20 | 33 | | 17 | | 100 rpm | 74 |
| 30 | 40 | | 22 | | 6 rpm | 24 |
| 40 | 47 | | 26 | | 3 rpm | 17 |
| 50 | 53 | | 31 | | | |
| 60 | 59 | | 35 | | | |

| | |
|---|---|
| % viscosity potential achieved after 60 minutes | 35.3% |

These results indicate that 35.3% of the viscosity potential is achieved after 1 hour at 600 RPM (59/167).

### Example VI

Following the general procedure with viscosifying composition of Formulation VI below, the mixture was mixed on a Caframo mixer. After 30 minutes, the sample thickened and did not stir well, but was still moveable. After one hour of mixing the sample was thick. There was almost no top oil separation after 24 hours. Rheology results are shown in Table VI.

Formulation VI

| Components | Wt % | Gm (oz) |
|---|---|---|
| TPM | 40 | 80 (2.82) |
| Glycerine | 5 | 10 (0.35) |
| Pyrol | 35 | 70 (2.47) |
| BARAVIS | 20 | 40 (1.41) |

TABLE VI

| | 16 lb/gal (1.917 g/cm³) Winter Blend | | | | | |
|---|---|---|---|---|---|---|
| | 1.5 lb (0.68 kg) | | | | | |
| | active | | | | roll | |
| | 7.5 gm (0.26 oz) | | | | 150° F./65° C. | Dial |
| Formulation VI | as recvd | | | | 16 hr | Reading |
| Time Min. | 600 | rpm | 300 | rpm | 600 rpm | 163 |
| 0 | 18 | | 9 | | 300 rpm | 117 |
| 10 | 38 | | 20 | | 200 rpm | 96 |
| 20 | 56 | | 32 | | 100 rpm | 71 |
| 30 | 71 | | 43 | | 6 rpm | 22 |
| 40 | 84 | | 53 | | 3 rpm | 17 |
| 50 | 94 | | 60 | | | |
| 60 | 102 | | 67 | | | |

| | |
|---|---|
| % viscosity potential achieved after 60 minutes | 62.6% |

These results indicate that 62.6% of the viscosity potential is achieved after 1 hour at 600 RPM (102/163).

### Example VII

Following the general procedure with viscosifying composition of Formulation VII below, the mixture was mixed on a Caframo mixer. The mixture thickened at about one hour without looking too thick. The mixture was allowed to continue mixing past 1 hour. About a ⅛ inch top oil separated after 24 hours, yet the mixture was still pourable and flowable. Rheology results are shown in Table VIIa and were repeated in Table VIIb.

Formulation VII

| Components | Wt % | gm (oz) |
|---|---|---|
| TPM | 45 | 90 (3.17) |
| Glycerine | 3 | 6 (0.21) |
| Pyrol | 32 | 64 (2.26) |
| BARAVIS | 20 | 40 (1.41) |

TABLE VIIa

| | 16 lb/gal (1.917 g/cm³) Winter Blend | | | | | |
|---|---|---|---|---|---|---|
| | 1.5 lb (0.68 kg) | | | | | |
| | active | | | | roll | |
| | 7.5 gm (0.26 oz) | | | | 150° F./65° C. | Dial |
| Formulation VII | as recvd | | | | 16 hr | Reading |
| Time Min | 600 | rpm | 300 | rpm | 600 rpm | 165 |
| 0 | 18 | | 9 | | 300 rpm | 120 |
| 10 | 26 | | 13 | | 200 rpm | 99 |
| 20 | 34 | | 18 | | 100 rpm | 74 |
| 30 | 43 | | 24 | | 6 rpm | 25 |
| 40 | 50 | | 29 | | 3 rpm | 18 |
| 50 | 58 | | 34 | | | |
| 60 | 64 | | 39 | | | |

| | |
|---|---|
| % viscosity potential achieved after 60 minutes | 38.8% |

TABLE VIIb

| | 16 lb/gal (1.917 g/cm³) Winter Blend | | | | | |
|---|---|---|---|---|---|---|
| | REPEAT | | | | | |
| | 1.5 lb (0.68 kg) | | | | | |
| | active | | | | roll | |
| | 7.5 gm (0.26 oz) | | | | 150° F./65° C. | Dial |
| Formulation VII | as recvd | | | | 16 hr | Reading |
| Time Min | 600 | rpm | 300 | rpm | 600 rpm | 162 |
| 0 | 16 | | 8 | | 300 rpm | 118 |
| 10 | 31 | | 16 | | 200 rpm | 99 |
| 20 | 43 | | 24 | | 100 rpm | 73 |
| 30 | 54 | | 31 | | 6 rpm | 24 |
| 40 | 64 | | 39 | | 3 rpm | 17 |
| 50 | 72 | | 45 | | | |
| 60 | 78 | | 49 | | | |

| | |
|---|---|
| % viscosity potential achieved after 60 minutes | 48.1% |

These results indicate that 38.8% and 48.1% (Tables VIIa and VIIIb, respectively) of the viscosity potential is achieved after 1 hour at 600 RPM in the two runs.

### Example VIII

This Example shows a 96 hour LC₅₀ study with the organism A. Bahia demonstrating the reduced toxicity of the propylene glycol ethers relative to ethylene glycol ethers.

Assays in Tables IX-XI below were conducted with a generic base mud in the presence and absence of the exemplary viscosifying composition of Formulation VI in EXAMPLE VI above. The methods and materials used to perform this test complied with the U.S. Environmental Protection Agency Test Methods, March, 1993, Drilling Fluid Toxicity Test, Appendix 2 of Subpart A 40 C.F.R. Part 435-Regulation for the Offshore Subcategory of the Oil and Gas Extraction Point Source Category, 58 FR No. 41, 12507-12511.

The drilling fluid samples were mixed thoroughly at 1000 rpm. The samples were then combined with filtered synthetic seawater at a 1:9 volume-to-volume ratio (drilling fluid to synthetic seawater, respectively) in one gallon plastic containers. The resulting mixtures were stirred for five minutes using magnetic stirrers. During this time, the pH was adjusted to 7.8 (+/−0.2) using 6N HCl or 5N NaOH, as necessary. The mixtures were allowed to settle for one hour and the preparation decanted from the settle mud into another plastic container. The pH and dissolved oxygen of each preparation was measured. The pH of each preparation was again adjusted to 7.8 (+/−0.2) as above, if necessary.

The temperature, salinity, dissolved oxygen and pH of each test concentration was measured daily. The number of surviving A. bahia was determined at the completion of the test. The 96 hour LC50 value (the concentration of the preparations lethal to 50% of the A. bahia at the end of 96 hours) was determined statistically or by observation. The results for three preparations are shown in Tables IX-XI below.

TABLE IX
Preparation 1: Generic Mud no Formulation VI present

Concentration

| | | 0% | 25% | 50% | 100% |
|---|---|---|---|---|---|
| | Run 1 | 18 | 17 | 19 | 14 |
| | Run 2 | 19 | 18 | 20 | 20 |
| | Run 3 | 19 | 19 | 20 | 17 |
| Total Survival | | 56 | 54 | 59 | 51 |
| Mortality | | 4 | 6 | 1 | 9 |
| Mean (%) at | | 93 | 90 | 98 | 85 |
| Test End | | | | | |

TABLE X
Preparation 2: Generic Mud + 1.25 lb/bbl Formulation VI

| | Concentration | 0% | 3% | 5% | 12% | 25% | 50% | 100% |
|---|---|---|---|---|---|---|---|---|
| | Run 1 | 19 | 20 | 19 | 20 | 16 | 19 | 16 |
| | Run 2 | 20 | 20 | 20 | 18 | 38 | 18 | 19 |
| | Run 3 | 18 | 18 | 20 | 19 | 20 | 20 | 18 |
| Total | | 57 | 58 | 59 | 57 | 74 | 57 | 53 |
| Survival | | | | | | | | |
| Mortality | | 3 | 2 | 1 | 3 | 6 | 3 | 7 |
| Mean (%) at | | 95 | 97 | 98 | 95 | 93 | 95 | 88 |
| Test End | | | | | | | | |

TABLE XI
Preparation 3: Generic Mud + 2.00 lb/bbl Formulation VI

| | Concentration | 0% | 3% | 6% | 12% | 25% | 50% | 100% |
|---|---|---|---|---|---|---|---|---|
| | Run 1 | 19 | 19 | 18 | 17 | 16 | 11 | 12 |
| | Run 2 | 20 | 19 | 19 | 17 | 19 | 15 | 15 |
| | Run 3 | 19 | 20 | 18 | 15 | 15 | 17 | 15 |
| Total | | 58 | 58 | 55 | 49 | 50 | 43 | 42 |
| Survival | | | | | | | | |
| Mortality | | 2 | 2 | 5 | 11 | 10 | 17 | 18 |
| Mean (%) at | | 97 | 97 | 92 | 82 | 83 | 72 | 70 |
| Test End | | | | | | | | |

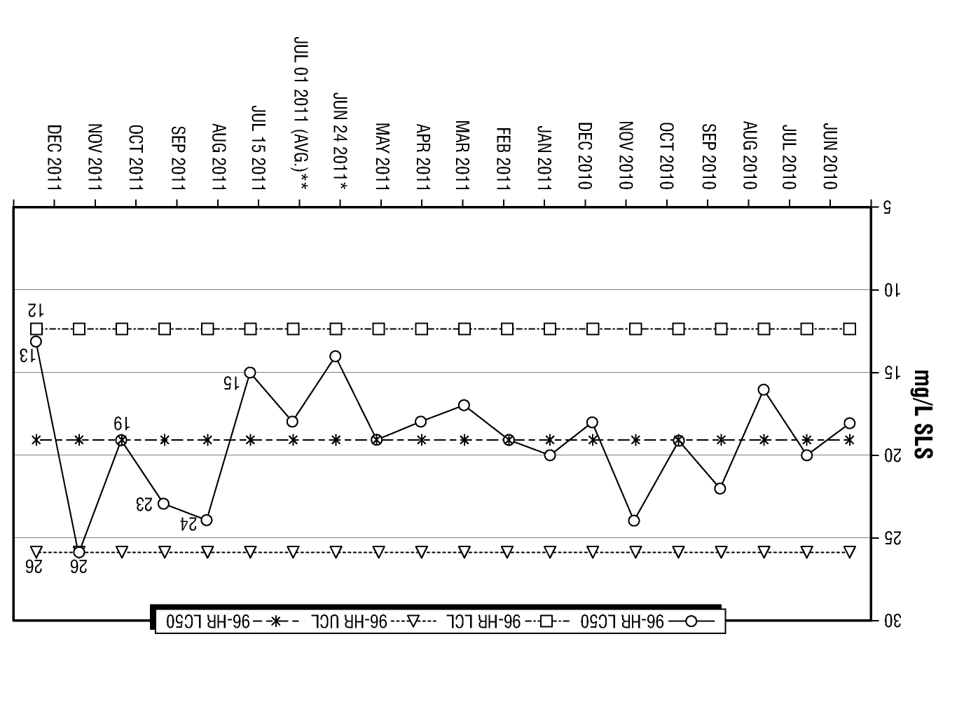

The test results indicate that each of Preparations 1-3 was greater than 1,000,000 ppm, which is higher than the current at filing time Gulf of Mexico NPDES permit limit of 30,000 ppm (Final NPDES General Permit for New and Existing Sources and New Dischargers in the Offshore Subcategory of the Oil and Gas Extraction Category for the Western Portion of the Outer Continental Shelf of the Gulf of Mexico (GMG290000), October 2007). These results also compare favorably to the toxicity of the ethylene glycol ether LC₅₀ values that are 559,900 at 1.25 lb/bbl and 106,700 at 2.0 lb/bbl. FIG. 1 shows a control chart for the 96 hour LC₅₀ test with Americamysis bahia. The chart indicates the general health of the test subject population prior to the 96 hour testing and indicates whether the population is within expected survival limits in its stock or storage environment.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a treatment fluid comprising a viscosifying composition and an aqueous base fluid, the viscosifying composition comprising:
hydroxyethyl cellulose;
about 10% to about 60% by weight of 2-pyrrolidone; and
about 10% to about 60% by weight of a water soluble monoalkyl ether of propylene glycol having substantially no swelling effect on the hydroxyethyl cellulose;
wherein a weight ratio of hydroxyethyl cellulose to 2-pyrrolidone comprises a range from about 1:2 to about 2.6:1; and
placing the treatment fluid in a subterranean formation.

2. The method of claim 1, wherein hydroxyethyl cellulose is present in a range from about 10% to about 25% by weight.

3. The method of claim 1, wherein the monoalkyl ether of propylene glycol comprises one selected from the group consisting of propylene glycol n-propyl ether, dipropylene glycol methyl ether, and tripropylene glycol methyl ether.

4. The method of claim 1, wherein the treatment fluid further comprises at least one water soluble salt of a multivalent metal ion.

5. The method of claim 4, wherein the at least one water soluble salt of a multivalent metal ion comprises one selected from the group consisting of calcium chloride, calcium bromide, zinc chloride, zinc bromide, and combinations thereof.

6. The method of claim 4, wherein the treatment fluid has a density greater than about 11.7 pounds per gallon.

7. The method of claim 4, wherein the treatment fluid has a density in a range from about 12.0 pounds per gallon to about 19.2 pounds per gallon.

8. The method of claim 1, wherein the treatment fluid further comprises glycerine.

9. The method of claim 1, wherein the treatment fluid comprises a workover fluid.

10. The method of claim 1, wherein the treatment fluid comprises a completion fluid.

11. The method of claim 1, wherein the treatment fluid comprises a drilling fluid.

12. The method of claim 1, wherein the treatment fluid further comprises an additive selected from the group consisting of an inert solid, a fluid loss control agent, a dispersion aid, a corrosion inhibitor, a gelling agent, a surfactant, a particulate, a proppant, a gravel particulate, a lost circulation material, a defoamer, a filtrate reducer, a pH control additive, a breaker, a biocide, a crosslinker, a stabilizer, a chelating agent, a scale inhibitor, a gas hydrate inhibitor, a mutual solvent, an oxidizer, a reducer, a flocculant, a friction reducer, a clay stabilizing agent, a shale control inhibitor, and any combination thereof.

13. A treatment fluid comprising a viscosifying composition and an aqueous base fluid, the viscosifying composition comprising:
hydroxyethyl cellulose;
about 10% to about 60% by weight of 2-pyrrolidone; and
about 10% to about 60% by weight of a water soluble monoalkyl ether of propylene glycol having substantially no swelling effect on the hydroxyethyl cellulose;
wherein a weight ratio of hydroxyethyl cellulose to 2-pyrrolidone comprises a range from about 1:2 to about 2.6:1.

14. The treatment fluid of claim 13, wherein the weight ratio of hydroxyethyl cellulose to 2-pyrrolidone comprises a range from about 2.6:1 to about 1:2.

15. The treatment fluid of claim 13, wherein hydroxyethyl cellulose is present in a range from about 10% to about 25% by weight.

16. The treatment fluid of claim 13, wherein the monoalkyl ether of propylene glycol comprises one selected from the group consisting of propylene glycol n-propyl ether, dipropylene glycol methyl ether, and tripropylene glycol methyl ether.

17. The treatment fluid of claim 13, further comprising at least one water soluble salt of a multivalent metal ion.

18. The treatment fluid of claim 17, wherein the at least one water soluble salt of a multivalent metal ion comprises one selected from the group consisting of calcium chloride, calcium bromide, zinc chloride, zinc bromide, and combinations thereof.

19. The treatment fluid of claim 17, wherein the treatment fluid has a density in a range from about 12.0 pounds per gallon to about 19.2 pounds per gallon.

20. A treatment fluid comprising a viscosifying composition and a brine base fluid, the viscosifying composition comprising:
hydroxyethyl cellulose;
about 10% to about 60% by weight of 2-pyrrolidone; and
about 10% to about 60% by weight of a water soluble monoalkyl ether of propylene glycol having substantially no swelling effect on the hydroxyethyl cellulose;
wherein a weight ratio of hydroxyethyl cellulose to 2-pyrrolidone comprises a range from about 1:2 to about 2.6:1.

21. A method comprising:
providing a treatment fluid comprising a viscosifying composition and an aqueous base fluid, the viscosifying composition comprising:
hydroxyethyl cellulose;
about 10% to about 60% by weight of 2-pyrrolidone; and
about 10% to about 60% by weight of a water soluble monoalkyl ether of propylene glycol having substantially no swelling effect on the hydroxyethyl cellulose;
wherein a weight ratio of hydroxyethyl cellulose to 2-pyrrolidone comprises a range from about 1:2 to about 2.6:1; and
placing the treatment fluid in a well bore of an offshore well as part of a workover or completion operation.

22. The method of claim 21, wherein the aqueous base fluid is a brine.
